(19) United States
(12) Patent Application Publication
(10) Pub. No.: US 2026/0178387 A1
(43) Pub. Date: Jun. 25, 2026

(54) Memory-Governed Supervisory and Evolutionary System with Adjudicated Memory Admission, Write-Barrier Constitutional Constraints, and Execution Separation Architecture

(71) Applicant: Xinxin Shan, surrey (CA)

(72) Inventor: Xinxin Shan, surrey (CA)

(73) Assignee: LED Smart Inc, Surrey (CA)

(21) Appl. No.: 19/540,150

(22) Filed: Feb. 13, 2026

(51) Int. Cl. G06F 9/50; G06F 3/0482; G06F 12/02; G06F 21/53

(52) U.S. Cl. CPC G06F 9/5022; G06F 3/0482; G06F 12/0253; G06F 21/53

(57) ABSTRACT

A memory-governed supervisory and evolutionary system is disclosed in which authority to influence system evolution is constitutionally constrained through adjudicated memory admission. Information from external sources and internally generated outputs is recorded as candidate memory resources within a structured memory architecture and rendered ineffective prior to adjudication by a write barrier. Admission occurs under a governance framework defining admissible evolution ranges, and system evolution arises exclusively from admitted structured memory resources. Supervisory outputs generated from admitted memory resources are expressive and non-executable, while execution and enforcement actions occur exclusively outside the system boundary. The disclosed architecture structurally separates information, authority, and execution, preventing delegation of authority to computation, intelligence, or external execution and enabling governed system evolution across asynchronous and heterogeneous environments.

### CROSS-REFERENCE TO RELATED APPLICATIONS

This application is an original application and does not claim priority to any prior application.

The subject matter disclosed herein defines a constitutional system architecture based on adjudicated memory admission within a structured memory architecture and structural separation between information, authority, and execution. The disclosed architecture may serve as a foundational basis for future continuation, divisional, or continuation-in-part applications directed to domain-specific implementations, integrations, or adaptations, provided that such applications remain consistent with the constitutional admission principles and structural constraints disclosed herein.

### PRIOR ART

The references listed below are submitted in fulfillment of the applicant's duty of disclosure and are identified as potentially relevant to the general technological environment relating to governance architectures, supervisory platforms, data lineage and provenance systems, auditability frameworks, distributed memory infrastructures, and policy-based information management systems. Inclusion of any reference herein shall not be construed as an admission that any reference constitutes prior art against the claimed invention or that any disclosed system anticipates or renders obvious the claimed subject matter. The disclosed invention defines a constitutional memory-governed supervisory architecture in which authority to influence system evolution arises exclusively through adjudicated admission of memory resources under write-barrier constraints, with structural separation between supervisory governance and external execution environments. The references are provided solely to assist examination and do not imply equivalence or structural identity with the disclosed architecture.

### US PATENT DOCUMENTS

U.S. Pat. No. 8,515,795 B2 August 2013 Marrelli et al.
U.S. Pat. No. 10,097,356 B2 October 2018 Zinder
U.S. Pat. No. 10,425,428 B2 September 2019 Krishnamurthy
U.S. Pat. No. 11,086,751 B2 August 2021 Moresmau et al.
U.S. Pat. No. 11,314,892 B2 April 2022 Nadler et al.
US 2021/0311871 A1 October 2021 Malladi et al.
US 2021/0311897 A1 October 2021 Malladi et al.
U.S. Pat. No. 11,416,431 B2 August 2022 Malladi et al.
US 2023/0020462 A1 January 2023 Malladi et al.
U.S. Pat. No. 9,659,042 B2 May 2017 Puri et al.
U.S. Pat. No. 10,318,283 B2 June 2019 Bach et al.
U.S. Pat. No. 11,347,482 B2 May 2022 Seetharaman et al.

### BACKGROUND OF THE INVENTION

Conventional intelligent systems, automated supervisory platforms, and control-oriented computational architectures commonly permit externally generated information, analytical outputs, computational results, inferred conclusions, or intelligent recommendations to directly influence system behavior or execution outcomes. In many such architectures, information presence is implicitly treated as authority, allowing decision engines, analytical processes, or artificial intelligence models to affect system evolution through operational mechanisms rather than through structurally governed admissibility constraints.

This implicit delegation of authority introduces structural risks including uncontrolled propagation of influence, opaque or non-auditable evolution pathways, unintended execution behavior, and difficulty maintaining governance across heterogeneous, distributed, or long-lived deployments. Existing solutions typically attempt to improve prediction accuracy, optimization performance, or decision responsiveness but do not address the foundational question of how authority to influence system evolution is constitutionally established.

Many existing architectures lack a formal separation between information presence and admissible authority, enabling computational or intelligent outputs to directly modify system state. Such arrangements may produce hidden feedback loops, implicit control dependencies, or governance ambiguity, particularly where asynchronous inputs, distributed environments, or independently operating external systems are involved.

Accordingly, there exists a need for a system architecture that constitutionally separates information generation from authority, prevents delegation of authority to computation, intelligence, or external execution environments, and ensures that system evolution arises exclusively through adjudicated admission of memory resources within a structured memory architecture. Such constitutional separation establishes a structural distinction between information presence and authority that is absent from conventional control-oriented or intelligence-driven architectures.

### SUMMARY OF THE INVENTION

The disclosed invention provides a memory-governed supervisory and evolutionary system in which authority to influence system evolution arises exclusively through adjudicated admission of memory resources under constitutional admissibility constraints.

Within a structured memory architecture, information originating from external sources or internally generated processes is received through at least one input interface and recorded as candidate memory resources. A write barrier positioned at the system boundary ensures that candidate memory resources remain constitutionally ineffective prior to adjudication and cannot influence system evolution absent admission.

At least one adjudication structure operating under a governance framework comprising boundary descriptors defining admissible evolution ranges determines whether candidate memory resources may be admitted as structured memory resources. Admission of structured memory resources constitutes the sole mechanism through which system evolution occurs.

At least one supervisory output structure generates expressive and non-executable supervisory outputs derived exclusively from admitted structured memory resources. Execution, enforcement, or actuation actions are performed exclusively outside the system boundary by independent external systems or actors operating under separate authority. Outcomes of external execution may be received as information and recorded as candidate memory resources subject to the same constitutional admission constraints.

The disclosed architecture establishes structural separation between information presence, authority, and execution, enabling governed system evolution across asynchronous, heterogeneous, and distributed environments while preventing delegation of authority to computation, intelligence, or external execution processes.

### BRIEF DESCRIPTION OF DRAWINGS

FIG. 1—System Reality Admission Constitution.

FIG. 2—Write Barrier and Ineffectiveness Prior to Adjudication.

FIG. 3—Memory Classification and Temporal Validity Constitution.

FIG. 4—Supervisory Output and External Execution Separation.

FIG. 5—Asynchronous and Heterogeneous Input Constitution.

### DETAILED DESCRIPTION OF THE INVENTION

The figures of this Section are expressive constitutional diagrams defining admissibility relations governing how information may participate in system evolution within a structured memory architecture. The illustrated relations do not represent operational steps, process flows, control logic, execution sequences, optimization routines, or decision-making behavior. All illustrated relations are declarative of constitutional constraints only and are single-direction, non-reversible, and declarative of constitutional admissibility relations rather than operational sequencing. System evolution is not determined by computational outputs, analytical results, intelligent reasoning, external execution, or human decision-making. Instead, system evolution arises exclusively from admission of memory resources through adjudication under a governance framework comprising boundary descriptors defining admissible evolution ranges.

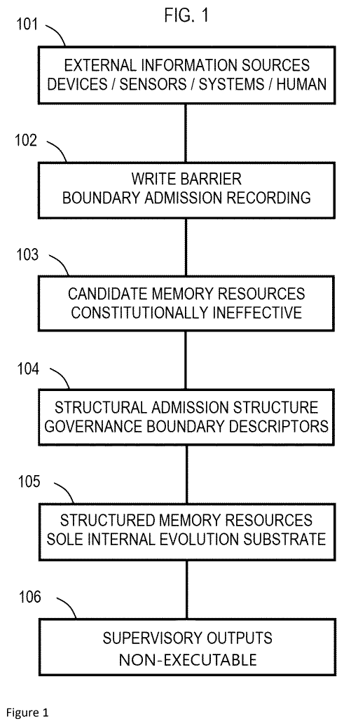

FIG. 1 illustrates a constitutional structure defining the sole admissible path by which information may become eligible to participate in system evolution. Element 101 represents external information sources of any origin, including devices, sensors, computational systems, analytical systems, intelligent systems, or human input mechanisms received through at least one input interface associated with the structured memory architecture, such information lacking authority to influence the system. Element 102 represents at least one write barrier positioned at the system boundary, the write barrier recording all information received from element 101 as candidate memory resources and rendering such information constitutionally ineffective to influence system evolution prior to adjudication. Element 103 represents candidate memory resources constitutionally present within the structured memory architecture but lacking authority to influence system evolution prior to adjudication. Element 104 represents at least one adjudication structure operating under a governance framework comprising boundary descriptors defining admissible evolution ranges, adjudication determining whether candidate memory resources may be admitted. The adjudication structure performs structural conformity determination relative to boundary descriptors rather than evaluative decision-making or rule-based judgment. Element 105 represents structured memory resources admitted through adjudication, structured memory resources constituting the sole internal substrate through which system evolution may occur. Element 106 represents at least one supervisory output structure generating supervisory outputs derived exclusively from structured memory resources, supervisory outputs being expressive and non-executable and not initiating, authorizing, or controlling execution or enforcement actions. The illustrated relations declare constitutional admissibility constraints rather than data flow, control flow, or execution order.

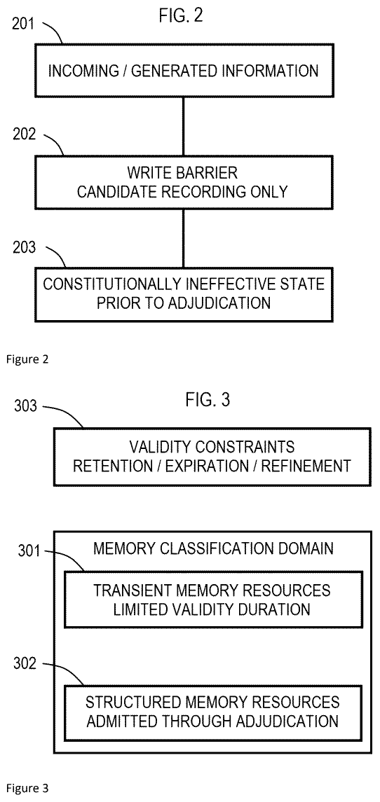

FIG. 2 illustrates constitutional constraints rendering information ineffective prior to adjudication. Element 201 represents incoming information and internally generated outputs of any type. Element 202 represents at least one write barrier of FIG. 1 recording such information as candidate memory resources within the structured memory architecture. Element 203 represents the constitutionally ineffective state of candidate memory resources prior to adjudication. No illustrated relation permits candidate memory resources, computational outputs, analytical results, or intelligent reasoning results to influence system evolution prior to admission through adjudication, all relations expressing declarative constitutional admissibility constraints rather than operational sequencing or execution behavior.

FIG. 3 illustrates constitutional classification of memory resources within the same structured memory architecture described in FIG. 1. Element 301 represents transient memory resources associated with limited validity durations. Element 302 represents structured memory resources admitted through adjudication. Element 303 represents validity constraints governing retention, expiration, refinement, or exclusion of memory resources. The illustrated relations define constitutional distinctions between provisional memory existence and admitted participation in system evolution, system evolution being governed through admission and refinement of structured memory resources rather than through repeated computation, execution, or operational control mechanisms.

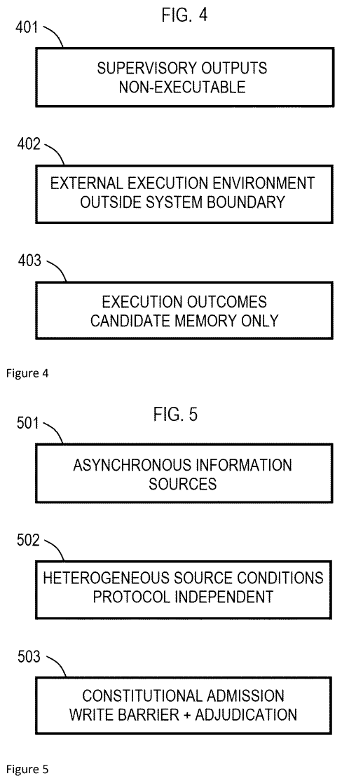

FIG. 4 illustrates constitutional separation between supervisory outputs and execution authority. Element 401 represents supervisory outputs generated by at least one supervisory output structure from admitted structured memory resources. Element 402 represents external execution and enforcement environments independent of the structured memory architecture and located outside the system boundary. Element 403 represents outcomes of external execution that may be received through at least one input interface and recorded as candidate memory resources. No illustrated relation implies execution, control, enforcement, or delegation of authority to the system, and authority to influence system evolution cannot be delegated to external execution, computation, analytical processes, intelligent reasoning, or human decision-making.

FIG. 5 illustrates constitutional tolerance to asynchronous and heterogeneous information conditions. Element 501 represents intermittent or asynchronous information sources. Element 502 represents heterogeneous source conditions independent of communication mechanisms. Element 503 represents constitutional admission through at least one write barrier and at least one adjudication structure without altering the constitutional admission structure defined in FIG. 1. The illustrated relations demonstrate that system correctness and evolution do not depend on real-time availability, synchronized input, continuous connectivity, or specific communication protocols, all relations expressing declarative constitutional admissibility constraints rather than operational procedures or execution flows.

Across FIG. 1 through FIG. 5, all illustrated relations are declarative of constitutional admissibility constraints and do not imply feedback control, closed-loop optimization, autonomous behavior, or execution authority. The disclosed system defines a constitutional structure in which authority to influence system evolution cannot be delegated to computation, intelligence, or external execution and arises exclusively from admission of memory resources through adjudication under governance constraints.

This Section describes constitutional structural relationships between the disclosed system and activities occurring outside the system boundary.

Nothing herein shall be interpreted as enabling, requiring, authorizing, or implying execution, control, enforcement, actuation, optimization, autonomous behavior, or decision-making by the system.

All computation, analysis, simulation, reasoning, or intelligent generation referenced herein serves solely to produce candidate memory resources.

Authority to influence system evolution cannot be delegated to computation, intelligence, human judgment, or external execution and arises exclusively from admission of memory resources through adjudication under a governance framework.

The disclosed system operates as a memory-governed supervisory and evolutionary platform that is constitutionally separated from execution and enforcement environments.

The system defines no execution pathways, control interfaces, decision logic, or enforcement mechanisms and does not perform actuation or autonomous decision-making.

Execution actions, control behaviors, enforcement activities, and actuation operations are performed exclusively outside the system boundary by external systems or actors operating under independent authority.

The disclosed system does not initiate, authorize, schedule, coordinate, recommend, optimize, or control execution or enforcement activity, nor does it delegate such authority to computational, intelligent, or human-in-the-loop processes.

Information representing outcomes of external execution or enforcement actions may be received through one or more input interfaces.

Such information may include measurements, observations, logs, confirmations, environmental conditions, state descriptions, error indications, or execution reports.

Upon receipt, all such information is recorded as candidate memory resources within a structured memory architecture and rendered constitutionally ineffective to influence system evolution prior to adjudication through a write barrier.

Candidate memory resources representing external outcomes are treated identically to all other information sources regardless of origin, perceived reliability, confidence level, or source authority.

No outcome information is treated as authoritative, validated, or binding solely by virtue of having resulted from execution or enforcement actions.

Authority to influence system evolution arises exclusively through adjudication under a governance framework comprising boundary descriptors defining admissible evolution ranges.

The governance framework defines admissible evolution ranges applicable to the system and may include contextual constraints, temporal constraints, scope constraints, resource constraints, or combinations thereof.

An adjudication structure evaluates candidate memory resources to determine whether such resources may be admitted as structured memory resources eligible to participate in system evolution.

Admission of structured memory resources constitutes the exclusive mechanism by which system evolution occurs.

Candidate memory resources remain constitutionally ineffective until admission through adjudication and cannot bypass the write barrier or governance constraints.

Supervisory outputs generated by the system are derived exclusively from admitted structured memory resources.

Such outputs are expressive and non-executable and do not initiate, authorize, command, recommend, optimize, or control execution or enforcement actions.

Presentation of supervisory outputs to external systems, operators, or processes does not impose obligation, duty, or authority and does not create a control, feedback, or dependency relationship.

Any correspondence between supervisory outputs and subsequent external execution arises solely from independent external interpretation and voluntary action.

No feedback control loop, closed-loop optimization, adaptive control, or automatic execution relationship is created between the system and any external execution environment.

Outcomes resulting from external interpretation or execution of supervisory outputs may be received by the system and recorded as candidate memory resources.

Such outcomes remain constitutionally ineffective prior to adjudication and do not bypass the write barrier, governance framework, or admissibility constraints governing system evolution.

System evolution occurs exclusively through admission of adjudicated memory resources.

The disclosed system remains operable under asynchronous conditions, intermittent connectivity, heterogeneous execution environments, and varying communication mechanisms.

System correctness and governance do not depend on real-time feedback, synchronized operation, continuous network availability, or specific communication protocols.

Through the foregoing constitutional mappings, the system maintains strict separation between memory governance and external execution.

No external execution, enforcement, computation, intelligence, or human decision may influence system evolution absent constitutional admission through adjudication.

### Example 1: Agricultural Irrigation Environment

In one non-limiting example, irrigation actions are performed by external systems or operators under independent authority.

Information describing soil conditions, environmental measurements, irrigation events, growth observations, or resulting conditions is received and recorded as candidate memory resources rendered constitutionally ineffective prior to adjudication.

Admitted structured memory resources may contribute to non-executable supervisory outputs describing historical patterns, contextual conditions, or explanatory representations related to irrigation.

Execution of irrigation actions remains entirely external to the system.

### Example 2: Heterogeneous and Distributed System Environment

In another non-limiting example, execution and enforcement activities are performed by heterogeneous external systems operating under different protocols, timing characteristics, operational constraints, or organizational authorities.

Information describing outcomes of such activities is recorded as candidate memory resources and rendered constitutionally ineffective prior to adjudication.

Supervisory outputs derived from admitted structured memory resources remain informational and non-executable.

### Example 3: Medical Advisory Environment

In another non-limiting example, medical observations or treatment outcomes are generated by external clinical systems or practitioners operating under independent authority.

Information describing diagnostic observations, treatment responses, monitoring results, or clinical outcomes is recorded as candidate memory resources.

Such information cannot influence system evolution unless admitted through adjudication.

Supervisory outputs remain expressive and non-executable.

### Example 4: Financial Compliance Environment

In another non-limiting example, financial activities or compliance actions are performed by external entities operating under independent regulatory authority.

Reports, audit records, transaction summaries, or compliance observations are recorded as candidate memory resources.

Admission into structured memory resources occurs exclusively through adjudication under boundary descriptors.

### Example 5: Industrial Monitoring Environment

In another non-limiting example, industrial monitoring or maintenance activities are performed by external operational systems.

Sensor readings, maintenance reports, operational logs, or performance observations are recorded as candidate memory resources and rendered constitutionally ineffective prior to adjudication.

Admitted structured memory resources may contribute to supervisory outputs describing contextual or historical conditions without initiating operational control.

1. A system embodied in non-transitory machine-readable memory and comprising one or more processors, the system comprising:
a structured memory architecture configured to store transient memory resources and structured memory resources;
at least one input interface configured to receive information originating from external sources without conferring authority on the received information;
at least one write barrier configured to require that received information and internally generated outputs are recorded as candidate memory resources and rendered constitutionally ineffective prior to adjudication;
at least one adjudication structure configured to determine whether candidate memory resources may be admitted as structured memory resources under a governance framework comprising boundary descriptors defining admissible evolution ranges; and
at least one supervisory output structure configured to generate non-executable outputs derived exclusively from admitted structured memory resources;
wherein execution actions and enforcement actions are performed exclusively outside the system and outcomes thereof are recorded solely as memory resources within the structured memory architecture; and
wherein system evolution is governed exclusively through admission of adjudicated memory resources rather than through direct influence of external inputs or generated outputs.

2. The system of claim 1, wherein the transient memory resources are associated with validity durations after which the transient memory resources are invalidated or discarded.

3. The system of claim 1, wherein the structured memory resources represent validity conditions, experiential records, historical outcomes, or composite state descriptors.

4. The system of claim 1, wherein at least one write barrier structurally prevents any candidate memory resource from influencing system evolution prior to adjudication.

5. The system of claim 1, wherein at least one input interface supports intermittent availability and asynchronous input without affecting system correctness.

6. The system of claim 1, wherein source identity, reliability, or confidence is represented as a memory resource constraining admissibility under the boundary descriptors.

7. The system of claim 1, wherein the boundary descriptors are static, dynamic, time-limited, scope-limited, or context-dependent.

8. A method performed by a supervisory and evolutionary platform comprising one or more processors, the method comprising:
receiving information from one or more external sources;
recording the received information as candidate memory resources within a structured memory architecture;
preventing the candidate memory resources from influencing system evolution prior to adjudication;
adjudicating the candidate memory resources under a governance framework comprising boundary descriptors defining admissible evolution ranges;
admitting selected candidate memory resources as structured memory resources;
generating non-executable supervisory outputs derived exclusively from admitted structured memory resources; and
recording outcomes of external execution or enforcement actions as memory resources.

9. The method of claim 8, wherein adjudicating the candidate memory resources comprises determining structural conformity with admissible evolution ranges defined by the boundary descriptors.

10. The method of claim 8, wherein generating supervisory outputs comprises generating explanatory, descriptive, or planning information marked as non-executable.

11. The method of claim 8, wherein recording outcomes of external execution actions comprises recording the outcomes as transient memory resources or structured memory resources.

12. The method of claim 8, wherein information originating from analytical, computational, intelligent, or human sources is treated as candidate memory resources without authority.

13. The method of claim 8, wherein system evolution occurs exclusively through admission of adjudicated memory resources.

14. The method of claim 8, wherein the method remains correct under asynchronous operation and intermittent inputs.

15. A non-transitory computer-readable medium storing instructions that, when executed by one or more processors, cause a system to:
maintain a structured memory architecture configured to store transient memory resources and structured memory resources;
receive information originating from external sources without conferring authority on the received information;
record received information and internally generated outputs as candidate memory resources and prevent the candidate memory resources from influencing system evolution prior to adjudication;
adjudicate the candidate memory resources under a governance framework comprising boundary descriptors defining admissible evolution ranges to determine whether the candidate memory resources may be admitted as structured memory resources;
generate non-executable supervisory outputs derived exclusively from admitted structured memory resources;
record outcomes of execution actions or enforcement actions performed outside the system as memory resources; and
wherein system evolution is governed exclusively through admission of adjudicated memory resources rather than through direct influence of external inputs or generated outputs.

16. The non-transitory computer-readable medium of claim 15, wherein the instructions support operation in the absence of any communication network.

17. The non-transitory computer-readable medium of claim 15, wherein the instructions support deployment on constrained processors having limited computational resources.

18. The non-transitory computer-readable medium of claim 15, wherein the boundary descriptors are dynamically updated based on adjudicated memory resources.

19. The non-transitory computer-readable medium of claim 15, wherein supervisory outputs include validity indicators or temporal applicability information.

20. The non-transitory computer-readable medium of claim 15, wherein analytical or intelligent resources are utilized exclusively as governed sources of candidate memory resources rather than as authorities determining system evolution.
